(19) United States
(12) Patent Application Publication
(10) Pub. No.: US 2002/0140866 A1
(43) Pub. Date: Oct. 3, 2002

(54) Method and circuit for an improved adaptive comb filter for separation of chrominance and luminance components from a composite video signal

(76) Inventors: Stephen D. Edwards, San Jose, CA (US); Duc Ngo, San Jose, CA (US)

Correspondence Address: WAGNER, MURABITO & HAO LLP, Two North Market Street, Third Floor, San Jose, CA, 95113, US

(21) Appl. No.: 09/823,428

(22) Filed: Mar. 30, 2001

(51) Int. Cl. H04N 9/78

(52) U.S. Cl. 348/665; 348/667

(57) ABSTRACT

A method and circuit thereof for detecting uncorrelated lines of chrominance of a composite video signal. A threshold level for determining whether lines of chrominance are correlated is defined. A comb filter is then used to separate the chrominance information from the luminance information of a composite video signal. In one embodiment, readings for three consecutive scan lines of chrominance are taken. If any of the adjacent scan lines contain the same color information or the difference is less than the threshold level, the scan lines are correlated. Otherwise, the adjacent scan lines are uncorrelated. If the lines are uncorrelated, a band pass filter is used to separate the chrominance component from the composite video signal. If the lines are correlated, the separation performed by the comb filter was appropriate and no other action is necessary. The present invention is an improved method of identifying chrominance scan lines that are uncorrelated, which in turn yields an improved adaptive comb filter.

### FIELD OF INVENTION

The present invention relates to the field of digital television. More specifically, the present invention relates to an improved adaptive comb filter for better separation of chrominance and luminance components from a composite video signal.

### BACKGROUND OF THE INVENTION

Many consumer electronic devices operate by displaying the contents of a composite video signal. The composite video signal prepared for broadcast contains luminance and chrominance information. The luminance information provides a black and white picture and the chrominance information adds color to the picture. As shown in chrominance information 100 of FIG. 1A, the chrominance information exists on a 3.58 MHz carrier subwave of sinusoidal shape. As shown in luminance information 120 of FIG. 1B, the luminance information exists in a triangle wave. Composite video signal 140 of FIG. 1C shows a composite video signal with both the chrominance and luminance information.

All consumer electronic devices operating on a composite video signal (e.g. televisions and video cassette recorders) require a filter to separate the luminance (Y) information from the chrominance (C) information. This process is performed by a Y/C separator. Two commonly used types of Y/C separators are comb filters and band pass filters.

A comb filter works by adding a scan line with its predecessor scan line. A scan line is a line a chrominance as it might appear as displayed horizontally on a monitor. Under both the National Television Standard Committee (NTSC) and the Phase Altering Line (PAL) television video signal formats, used in the United States and Europe respectively, the chrominance phase changes 180 degrees from one scan line to the next (this is not true with respect to the luminance component). As a result, if two adjacent identical (e.g., correlated) scan lines are added, then the chrominance component is completely removed leaving only luminance. However, if two adjacent scan lines are not identical (e.g., uncorrelated), which is the case with most natural images, then the separation can be very poor. The quality of the Y/C separation is directly related to the degree of correlation between two adjacent scan lines. A comb filter is typically used where adjacent scan lines of chrominance are correlated.

A band pass filter operates by filtering out the color information from composite video, thus leaving only the luminance information. The color information exists in a 3.58 MHz carrier subwave. The band pass filter is set to reject frequencies above a specified frequency. Although this effectively filters most of the chrominance signal out of the luminance signal, it also removes the higher frequency luminance signal components. As a result, horizontal and vertical resolution is lost and color artifacts are introduced at the boundaries of different colors, thus reducing the quality of the picture. A band pass filter is typically used where adjacent scan lines of chrominance are uncorrelated.

### SUMMARY OF THE INVENTION

Accordingly, a need exists for a method and a circuit thereof for detecting whether adjacent lines of chrominance of a composite video signal are correlated or uncorrelated, and thus determining which type of filter should be used for Y/C separation. Furthermore, there is a need for such a method that is also commercially economical. The present invention provides these advantages and others not specifically mentioned above but described in the sections to follow.

A method and circuit thereof for detecting correlated lines of chrominance of a composite video signal is described. First, a comb filter is used to separate the chrominance information from the luminance information of a composite video signal. Next, a plurality of consecutive scan lines of chrominance is examined. Two adjacent scan lines of chrominance are then added together, resulting in a first value. If the first value is not greater than a predetermined threshold value, the adjacent lines of chrominance are determined to be correlated. Otherwise, the adjacent lines of chrominance are determined to be uncorrelated.

In one embodiment, in the event of correlated lines, the earlier comb filter separation is appropriate, so no further action is taken. In one embodiment, in the event of uncorrelated lines, a band pass filter is used to separate the chrominance information from the composite video signal.

In one embodiment, the chrominance readings for three consecutive scan lines are taken. The first line and second line are added together resulting in a first value and the second line and third line are added together resulting in a second value. The first value and the second value are compared to a predetermined threshold value to determine whether the lines of chrominance are correlated or uncorrelated with each other.

If both the first value and the second value are not less than a predetermined threshold value the first line, second line, and third line are determined to be uncorrelated. In one embodiment, a band pass filter is used to separate the chrominance component from the composite video signal. Otherwise, if it is determined that the first, second, and third lines of chrominance are correlated. In one embodiment, a three-line comb filter is used to separate the chrominance component from the composite video signal.

If only the first value is not less than the predetermined threshold value, it is determined that the first line of chrominance and the second line of chrominance are uncorrelated and that the second line of chrominance and the third line of chrominance are correlated. In one embodiment, a band pass filter is used to separate the chrominance component from the composite video signal for the first and second lines.

Conversely, if only the second value is not less than the predetermined threshold value, it is determined that the first line of chrominance and the second line of chrominance are correlated and that the second line of chrominance and the third line of chrominance are uncorrelated. In one embodiment, a band pass filter is used to separate the chrominance component from the composite video signal for the second and third lines.

In one embodiment, the predetermined threshold value is a user defined threshold factor. In another embodiment, the predetermined threshold value is a user defined threshold value multiplied by the average chrominance amplitude of two consecutive lines of chrominance, thus normalizing the threshold value to account for variances in the amplitude of the chrominance information.

The present invention provides an improved method of identifying chrominance scan lines that are not correlated, which in turn yields an improved adaptive comb filter. Thus, in accordance with the present invention, a consumer electronic device operating on a composite video signal can produce a clearer picture. The present invention can be integrated into conventional television technology by replacing circuitry or upgrading software. Consequently, the present invention increases quality of a video picture, adds minimal cost to the electronic device, and is readily interchangeable with the prior art.

These and other objects and advantages of the present invention will become obvious to those of ordinary skill in the art after having read the following detailed description of the preferred embodiments which are illustrated in the various drawing figures.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1A shows a graphical representation of an exemplary chrominance component of a composite video signal in accordance with the prior art.

FIG. 1B shows a graphical representation of an exemplary luminance component of a composite video signal in accordance with the prior art.

FIG. 1C shows a graphical representation of an exemplary composite video signal comprising a chrominance and luminance component in accordance with the prior art.

FIG. 2 shows a flowchart diagram of a process for examining a plurality of adjacent lines of chrominance and determining whether the adjacent lines of chrominance or uncorrelated in accordance with one embodiment of the present invention.

FIGS. 3A and 3B shows a flowchart diagram of a process for examining three consecutive lines of chrominance and determining whether the lines of chrominance or uncorrelated in accordance with one embodiment of the present invention.

FIG. 4 shows a block diagram of three adjacent scan lines of chrominance of a composite video signal in accordance with one embodiment of the present invention.

FIG. 5 shows a circuit diagram of a circuit for examining a plurality of consecutive lines of chrominance and determining whether the lines of chrominance are uncorrelated in accordance with one embodiment of the present invention.

FIG. 6 shows a circuit diagram of a circuit for examining three consecutive lines of chrominance and determining whether the lines of chrominance are uncorrelated in accordance with one embodiment of the present invention.

### DETAILED DESCRIPTION

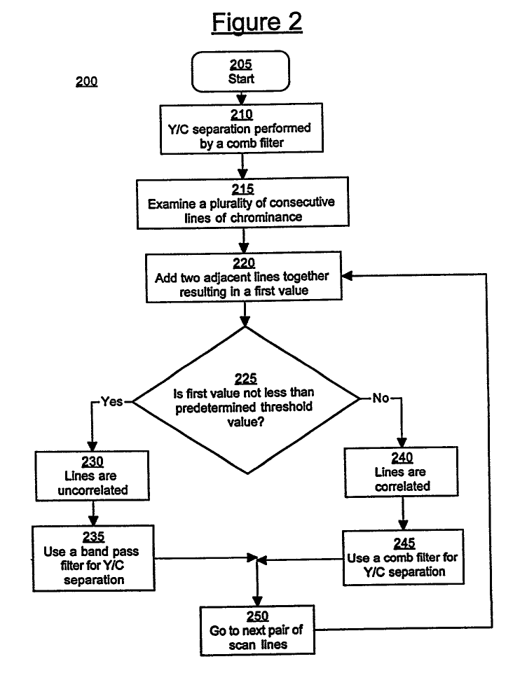

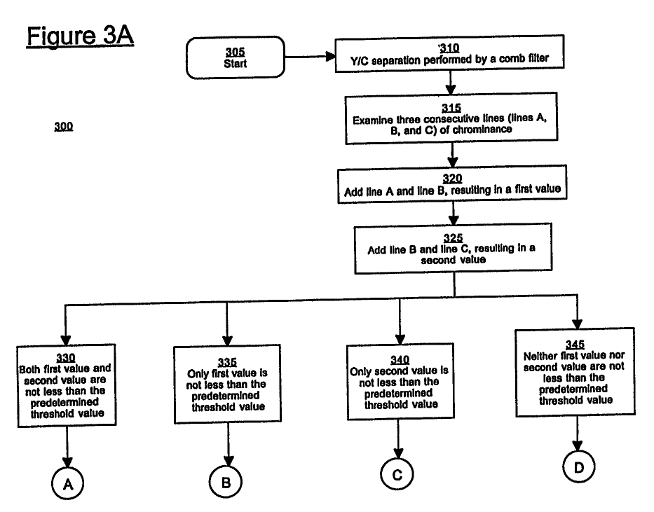

FIG. 2 shows a flowchart diagram of a process 200 for examining a plurality of adjacent lines of chrominance and determining whether the adjacent lines of chrominance are correlated or uncorrelated in accordance with one embodiment of the present invention.

At step 205 of process 200, the process begins. In one embodiment of the present invention, as shown at step 210, a comb filter is used to initially separate the chrominance component from the luminance component (e.g., Y/C separation) of a composite video signal. In another embodiment, a band pass filter is used to initially separate the chrominance component from the luminance component. It should be appreciated that any filter type of can be used to perform the initial Y/C separation.

At step 215, a plurality of consecutive scan lines of chrominance of a composite video signal are examined. In one embodiment, two consecutive scan lines of chrominance are examined. In another embodiment, three consecutive scan lines of chrominance are examined.

At step 220, two adjacent scan lines of chrominance are added together, resulting in a first value. NTSC and PAL chrominance signals have the property that adjacent scan lines of chrominance have opposite signs. For example, if two adjacent scan lines are identical, when the two lines are added together their signals equal zero.

At step 225, in one embodiment, it is determined whether the first value is not less than a predetermined threshold value. The predetermined threshold level is used to account for slight variances in scan lines, such that two slightly different scan lines can be considered identical for the purposes of process 200.

In one embodiment, the predetermined threshold value is a user defined threshold factor. The present embodiment is useful in situations where the chrominance amplitude is known, such as a controlled situation. There is no need to determine the average chrominance amplitude, thus providing a low cost thresholding alternative in controlled situations.

In another embodiment, the predetermined threshold value is a user defined threshold value multiplied by the average chrominance amplitude of two consecutive lines of chrominance, thus normalizing the threshold value to account for variances in the amplitude of the chrominance information.

T=T_{corr}*Tₐᵥ Equation 1

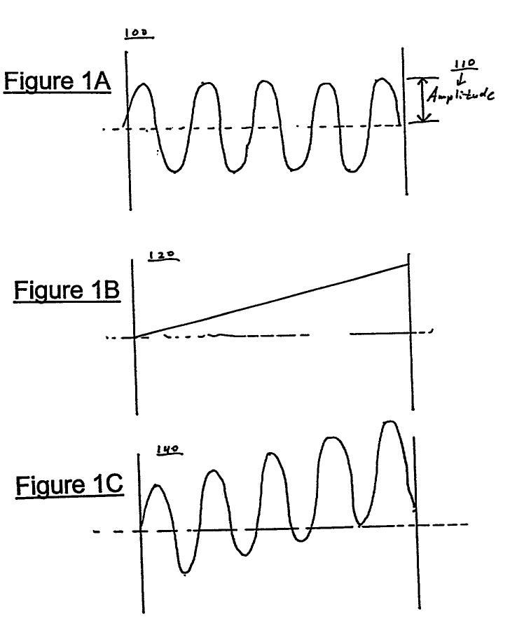

Equation 1 represents the current embodiment, where T represents the threshold used to compare to first value, T_{corr} represents a user selectable threshold value, and Tₐᵥ represents the average chrominance amplitude of scan lines (e.g. amplitude 110 of FIG. 1A). The present embodiment is useful in situations where the chrominance amplitude may vary, such as typical broadcast signals for television.

If the first value is not less than the threshold value, as shown at step 230, it is determined that the scan lines of chrominance are uncorrelated. Otherwise, as shown at step 240, it is determined that the scan lines of chrominance are correlated.

In one embodiment, as shown at step 235, a band pass filter is used to separate the chrominance component and the luminance component from the composite video signal. In situations of uncorrelated scan lines of chrominance, a band pass filter typically provides a better quality image than a comb filter.

In the instance of correlated scan lines of chrominance, as shown at step 245, a comb filter typically provides the best quality picture. In one embodiment, a comb filter is used to separate the chrominance component from the luminance component. In another embodiment, as a comb filter was used to perform the initial Y/C separation (see step 210), there is no need for additional filtering or repeat filtering.

It should be appreciated that process 200 is not dependent on the use of band pass filters or comb filters. Process 200 is used to determine whether scan lines of chrominance are correlated or uncorrelated. Upon making this determination, a different filter may be used than initially used to perform Y/C separation. Any number of different filters, or combinations of filters may be used to perform the Y/C separation.

At step 250, process 200 returns to step 220 to add the next pair of adjacent scan lines of chrominance. It should be appreciated that process 200 is repeated continuously for all scan lines in a composite video signal.

The present invention is an improved method of identifying chrominance scan lines that are uncorrelated, which in turn yields an improved adaptive comb filter.

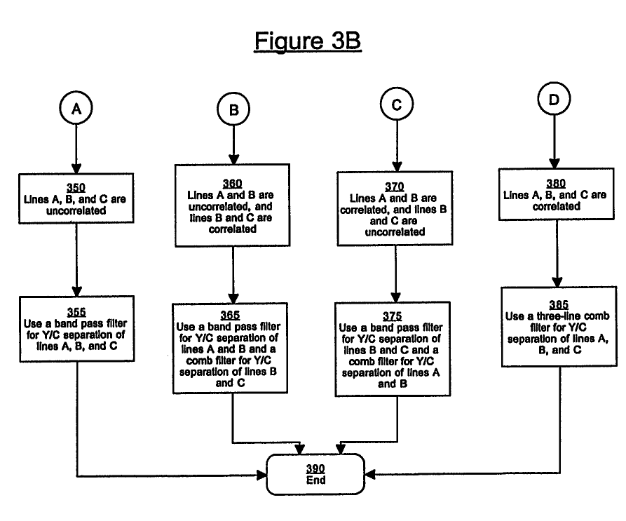

FIGS. 3A and 3B shows a flowchart diagram of a process 300 for examining three consecutive lines of chrominance and determining whether the lines of chrominance are uncorrelated in accordance with one embodiment of the present invention.

At step 305 of process 300, the process begins. In one embodiment of the present invention, as shown at step 310, a comb filter is used to separate the chrominance component from the luminance component (e.g., Y/C separation) of a composite video signal. In another embodiment, a band pass filter is used to initially separate the chrominance component from the luminance component. It should be appreciated that any filter type of can be used to perform the initial Y/C separation.

At step 315, three consecutive scan lines of chrominance of a composite video signal are examined. The three consecutive scan lines of chrominance comprise line A, line B, and line C.

At step 320, line A and line B are added together, resulting in a first value. Similarly, as shown at step 325, line B and line C are added together, resulting in a second value. NTSC and PAL chrominance signals have the property that adjacent scan lines of chrominance have opposite signs. For example, if two adjacent scan lines are identical, when the two lines are added together their signals equal zero.

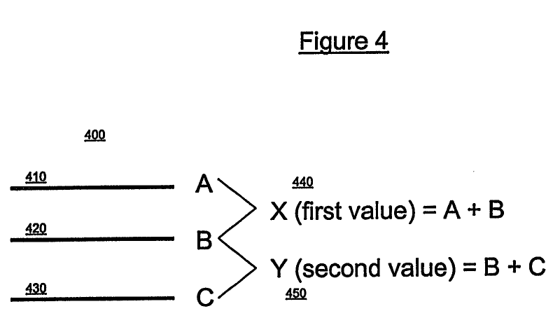

FIG. 4 shows a diagram 400 of three adjacent scan lines of chrominance of a composite video signal in accordance with one embodiment of the present invention. Diagram 400 is a representation of the events occurring at steps 315, 320, and 325 of process 300 (FIG. 3A). Line A 410 and line B 420 are added together, resulting in X 440 (e.g. the first value of step 320 of FIG. 3A). Likewise, Line B 420 and line C 430 are added together, resulting in Y 450 (e.g. the second value of step 325 of FIG. 3A).

Returning to FIG. 3A, the first value and the second value are compared to a predetermined threshold value. The predetermined threshold level is used to account for slight variances in scan lines, such that two slightly different scan lines can be considered identical for the purposes of process 300.

In one embodiment, as previously described, the predetermined threshold value is a user defined threshold factor. The present embodiment is useful in situations where the chrominance amplitude is known, such as a controlled situation. There is no need to determine the average chrominance amplitude, thus providing a low cost thresholding alternative in controlled situations.

In another embodiment, the predetermined threshold value is a user defined threshold value multiplied by the average chrominance amplitude of two consecutive lines of chrominance, thus normalizing the threshold value to account for variances in the amplitude of the chrominance information.

Tₓ=T_{corr}*T_{Xav} Equation 2

T_{Y}=T_{corr}*T_{Yav} Equation 3

Equations 2 and 3 represent the current embodiment, where T_{X} represents the threshold used to compare to the first value, T_{Y} represents the threshold used to compare to the second value, T_{corr} represents a user selectable threshold value, T_{Xav} represents the average chrominance amplitude of scan lines A and B, and T_{Yav} represents the average chrominance amplitude of scan lines B and C. The present embodiment is useful in situations where the chrominance amplitude may vary, such as typical broadcast signals for television.

In comparing the first value and second value to the predetermined threshold level, four alternatives arise.

In the first alternative, as shown at step 330, both the first value and the second value are not less than the predetermined threshold level. Thus it is determined that line A, line B, and line C are all uncorrelated, as shown at step 350. At step 355, a band pass filter is used for Y/C separation of lines A, B and C.

In the second alternative, as shown at step 335, only the first value is not less than the predetermined threshold value. Thus it is determined that line A and line B are uncorrelated and line B and line C are correlated, as shown at step 360. In one embodiment, as shown at step 365, a band pass filter is used to perform the Y/C separation of line A and line B and a comb filter is used to perform the Y/C separation of line B and line C. In another embodiment, as a comb filter was used to perform the initial Y/C separation (see step 310), there is no need for additional filtering or repeat filtering of line B and line C.

In the third alternative, as shown at step 340, only the second value is not less than the predetermined threshold value. Thus it is determined that line A and line B are correlated and line B and line C are uncorrelated, as shown at step 370. In one embodiment, as shown at step 375, a band pass filter is used to perform the Y/C separation of line B and line C and a comb filter is used to perform the Y/C separation of line A and line B. In another embodiment, as a comb filter was used to perform the initial Y/C separation (see step 310), there is no need for additional filtering or repeat filtering of line A and line B.

In the fourth alternative, as shown at as shown at step 345, neither the first value nor the second value are not less than the predetermined threshold level. Thus it is determined that line A, line B, and line C are all correlated, as shown at step 380. In one embodiment, as shown at step 385, a three-line comb filter is used for Y/C separation of lines A, B and C. In another embodiment, no additional or alternative filtering is performed, as the initial comb filtering is deemed satisfactory.

At step 390, process 300 ends. It should be appreciated that process 300 is repeated continuously for all sets of three consecutive scan lines of chrominance in a composite video signal.

As with process 200 of FIG. 2, it should be appreciated that process 300 of FIGS. 3A and 3B is not dependent on the use of band pass filters or comb filters. Process 300 is used to determine whether three consecutive scan lines of chrominance are correlated or uncorrelated. Upon making this determination, a different type of filter than the type of filter initially used may be used to perform Y/C separation. Any number of different filters, or combinations of filters may be used to perform the Y/C separation.

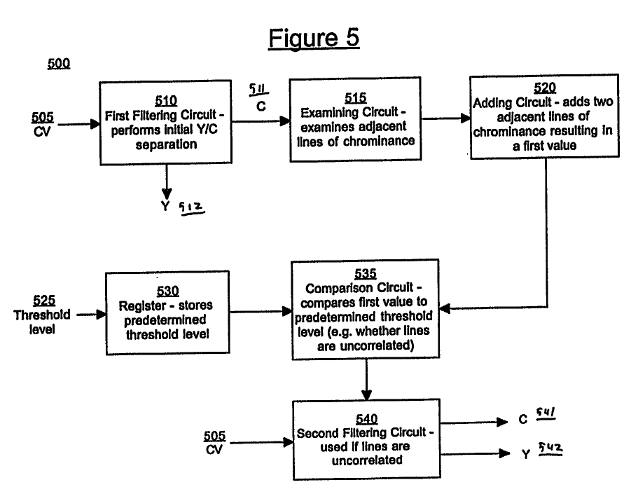

FIG. 5 shows a circuit diagram of a circuit 500 for examining a plurality of consecutive lines of chrominance and determining whether the lines of chrominance are uncorrelated in accordance with one embodiment of the present invention.

Composite video signal 505 is passed through first filtering circuit 510 for separating the chrominance information (C) 511 and luminance information (Y) 512. In one embodiment, first filtering circuit is a comb filter. It should be appreciated that first filtering circuit 510 can be any type of chrominance filter, and is not meant to be limited to any particular type of Y/C separator. First filtering circuit is coupled to examining circuit 515.

Examining circuit 515 is configured for examining a plurality of consecutive scan lines of chrominance. In one embodiment, two consecutive scan lines of chrominance are examined. In another embodiment, three consecutive scan lines of chrominance are examined. Examining circuit 515 is coupled to adding circuit 520.

Adding circuit 520 is configured for adding two of the plurality of consecutive scan lines of chrominance resulting in a first value. NTSC and PAL chrominance signals have the property that adjacent scan lines of chrominance have opposite signs. For example, if two adjacent scan lines are identical, when the two lines are added together their signals equal zero. Adding circuit 520 is coupled to comparison circuit 535.

Register 530 is for storing a predetermined threshold value 525. The predetermined threshold level is used to account for slight variances in scan lines, such that two slightly different scan lines can be considered identical for the purposes of process 500.

In one embodiment, the predetermined threshold value is a user defined threshold factor. The present embodiment is useful in situations where the chrominance amplitude is known, such as a controlled situation. There is no need to determine the average chrominance amplitude, thus providing a low cost thresholding alternative in controlled situations.

In another embodiment, the predetermined threshold value is a user defined threshold value multiplied by the average chrominance amplitude of two consecutive lines of chrominance, thus normalizing the threshold value to account for variances in the amplitude of the chrominance information. Register 530 is coupled to comparison circuit 535.

Comparison circuit 535 is configured for determining whether the first value is not less than the predetermined threshold value. If the first value is not less than said predetermined threshold value, it is determined that the scan lines of chrominance are uncorrelated. Otherwise, it is determined that the scan lines of chrominance are correlated. Comparison circuit 535 is coupled to second filtering circuit 540.

Second filtering circuit 540 is configured for separating chrominance information from composite video signal 505. Second filtering circuit 540 is operable if the lines of chrominance are uncorrelated. Second filtering circuit 540 performs an alternative Y/C separation, replacing the initial Y/C separation performed by first filtering circuit 510, resulting in chrominance information (C) 541 and luminance information (Y) 542.

In one embodiment, if it is determined that the scan lines of chrominance are correlated, no further action is necessary. The Y/C separation performed by first filtering circuit 510 is desirable as the lines of chrominance are correlated. In another embodiment, a different chrominance filter may be used for Y/C separation where the scan lines are correlated.

It should be appreciated that circuit 500 is not dependent on the use of band pass filters or comb filters. Circuit 500 is used to determine whether scan lines of chrominance are correlated or uncorrelated. Upon making this determination, a different filter may be used than initially used to perform Y/C separation. Any number of different filters, or combinations of filters may be used to perform the Y/C separation.

The present invention is an improved method of identifying chrominance scan lines that are uncorrelated, which in turn yields an improved adaptive comb filter.

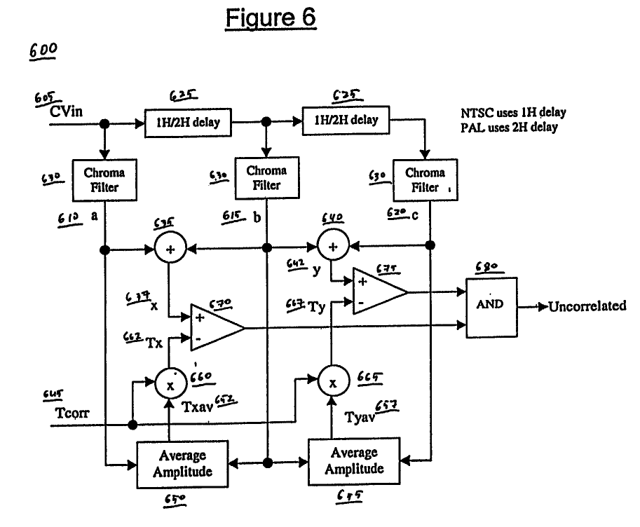

FIG. 6 shows a circuit diagram of a circuit 600 for examining three consecutive lines of chrominance, line A 610, line B 615, and line C 620, and determining whether the lines of chrominance are uncorrelated in accordance with one embodiment of the present invention.

Composite video signal (CVᵢₙ) 605 is passed through a chrominance filter 630 for line A 610, line B 615, and line C 620 for separating the chrominance component from the luminance component of composite video signal 605. In one embodiment, chrominance filter 630 is a comb filter. It should be appreciated that any type of chrominance filter can be used to separate the chrominance component from the luminance component, and chrominance filter 630 is not meant to be limited to any one type of chrominance filter.

In one embodiment, where the composite video signal is in NTSC broadcast format, there is a one horizontal scan line delay 625 between line A 610 and line B 615 and a is a one horizontal scan line delay 625 between line B 615 and line C 620. In another embodiment, where the composite video signal is in PAL broadcast format, there is a two horizontal scan line delay 625 between line A 610 and line B 615 and a is a two horizontal scan line delay 625 between line B 615 and line C 620.

Adder 635 adds the chrominance components of line A 610 and line B 615, resulting in a first value (X) 637. Similarly, adder 640 adds the chrominance components of line B 615 and line C 620, resulting in a second value (Y) 642.

In one embodiment, a threshold value (T_{corr}) 645 is input by a user. Averager 650 calculates the average chrominance amplitude 652 of line A 610 and line B 615 (e.g., amplitude 110 of FIG. 1A). Multiplier 660 multiplies threshold value 645 and average chrominance amplitude 652, resulting in a first threshold value (T_{X}) 662. Similarly, averager 655 calculates the average chrominance amplitude 657 of line B 615 and line C 620. Multiplier 665 multiplies threshold value 645 and average chrominance amplitude 657, resulting in a second threshold value (T_{Y}) 667.

In another embodiment, only threshold value 645 is used to determine threshold values 662 and 667. This is useful in situations where the average chrominance amplitude is known and constant, thus providing a less expensive alternative in certain situations.

Comparator 670 compares first value 637 and first threshold value 662, determining whether first value 637 is not less than first threshold value 662. If first value 637 is not less than first threshold value 662, comparator 670 notifies gate 680.

Similarly, comparator 675 compares second value 642 and second threshold value 667, determining whether second value 642 is not less than second threshold value 667. If second value 642 is not less than second threshold value 667, comparator 675 notifies gate 680.

In one embodiment, gate 680 is an AND gate. In the present embodiment, if both comparator 670 notifies gate 680 that first value 637 is not less than first threshold value 662 and comparator 675 notifies gate 680 that second value 642 is not less than second threshold value 667, it is determined that line A 610, line B 615, and line C 620 are uncorrelated.

In one embodiment, in the situation where line A 610, line B 615, and line C 620 are all uncorrelated, a band pass filter is used for Y/C separation. In the present embodiment, composite video signal 605 is passed through a band pass filter for Y/C separation. It should be appreciated that any type of Y/C separation filter can be used to perform the Y/C separation.

In another embodiment, gate 680 is an OR gate. In the present embodiment, if either comparator 670 notifies gate 680 that first value 637 is not less than first threshold value 662 and comparator 675 notifies gate 680 that second value 642 is not less than second threshold value 667, it is determined that only the lines associated with the notifying comparator are uncorrelated.

In one embodiment, in the situation where line A 610 and line B 615 are uncorrelated, a band pass filter is used for Y/C separation of only line A 610 and line B 615. In the present embodiment, composite video signal 605 is passed through a band pass filter for Y/C separation. It should be appreciated that any type of Y/C separation filter can be used to perform the Y/C separation. Additionally, as line B and line C are correlated, the initial Y/C separation is satisfactory with respect to those lines. The present embodiment holds true in the situation where line B 615 and line C 620 are uncorrelated.

The preferred embodiment of the present invention, a method and circuit thereof for detecting uncorrelated lines of chrominance of a composite video signal, is thus described. While the present invention has been described in particular embodiments, it should be appreciated that the present invention should not be construed as limited by such embodiments, but rather construed according to the below claims.

What is claimed is:

1. A method for detecting uncorrelated lines of chrominance of a composite video signal comprising the steps of:
a) separating chrominance information and luminance information from a composite video signal using a first filter;
b) examining a plurality of consecutive lines of chrominance information;
c) adding two of said plurality of consecutive lines of chrominance, resulting in a first value;
d) provided said first value is not greater than a predetermined threshold value, determining that said consecutive lines of chrominance are correlated, otherwise determining that said consecutive lines of chrominance are uncorrelated; and
e) provided said consecutive lines of chrominance are uncorrelated, using a second filter to separate said chrominance component from said composite video signal.

2. The method as recited in claim 1 further comprising the step of provided said consecutive lines of chrominance are correlated, using a third filter to separate said chrominance component from said composite video signal.

3. The method as recited in claim 1 wherein said first filter is a comb filter.

4. The method as recited in claim 1 wherein said second filter is a band pass filter.

5. The method as recited in claim 2 wherein said third filter is a two-dimensional comb filter.

6. The method as recited in claim 1 wherein said step a) comprises the step of examining two consecutive lines of chrominance.

7. The method as recited in claim 1 wherein said step a) comprises the step of examining three consecutive lines of chrominance.

8. The method as recited in claim 1 wherein said predetermined threshold value is a user defined threshold factor.

9. The method as recited in claim 1 wherein said predetermined threshold value is a user defined threshold factor multiplied by the average chrominance amplitude of said two consecutive lines of chrominance.

10. A circuit for detecting uncorrelated lines of chrominance of a composite video signal comprising:
a first filtering circuit for separating chrominance information and luminance information from a composite video signal;
an examining circuit for examining a plurality of consecutive lines of chrominance, said examining circuit coupled to said first filtering circuit;
an adding circuit for adding two of said plurality of consecutive lines of chrominance resulting in a first value, said adding circuit coupled to said examining circuit;
a register having stored upon it a predetermined threshold value;
a comparison circuit for determining whether said first value is not less than said predetermined threshold value, said comparison circuit coupled to said register and said adding circuit; and
a second filtering circuit for separating chrominance information from said composite video signal, said second filtering circuit operating if said lines of chrominance are uncorrelated, wherein said lines of chrominance are uncorrelated where said first value is not less than said predetermined threshold value, otherwise said lines of chrominance are correlated.

11. The circuit as recited in claim 10 further comprising a third filtering circuit, said third filtering circuit operating if said lines of chrominance are correlated.

12. The circuit as recited in claim 10 wherein said first filtering circuit is a comb filter.

13. The circuit as recited in claim 10 wherein said second filtering circuit is a band pass filter.

14. The circuit as recited in claim 11 wherein said third filtering circuit is a two-dimensional comb filter.

15. The circuit as recited in claim 10 wherein said examining component examines two consecutive lines of chrominance.

16. The circuit as recited in claim 10 wherein said examining component examines three consecutive lines of chrominance.

17. The circuit as recited in claim 10 wherein said predetermined threshold value is a user defined threshold factor.

18. The circuit as recited in claim 10 wherein said predetermined threshold value is a user defined threshold factor multiplied by the average chrominance amplitude of said two consecutive lines of chrominance.

19. A method for detecting uncorrelated lines of chrominance of a composite video signal comprising the steps of:
a) separating the chrominance information and luminance information from a composite video signal using a first filter;
b) examining three consecutive lines of chrominance, said consecutive lines comprising a first line of chrominance, a second line of chrominance, and a third line of chrominance;
c) adding said first line of chrominance and said second line of chrominance, resulting in a first value;
d) adding said second line of chrominance and said third line of chrominance, resulting in a second value;
e) provided both said first value and said second value are not less than a predetermined threshold value, determining that said first line of chrominance, said second line of chrominance, and said third line of chrominance are uncorrelated and using a second filter to separate said chrominance component from said composite video signal;
f) provided only said first value is not less than said predetermined threshold value, determining that said first line of chrominance and said second line of chrominance are uncorrelated and that said second line of chrominance and said third line of chrominance are correlated, and using said second filter to separate said chrominance component from said composite video signal for said first line and said second line;
g) provided only said second value is not less than said predetermined threshold value, determining that said first line of chrominance and said second line of chrominance are correlated and that said second line of chrominance and said third line of chrominance are uncorrelated, and using said second filter to separate said chrominance component from said composite video signal for said second line and said third line; and
h) provided neither said first value nor said second value are not less than a predetermined threshold value, determining that said first line of chrominance, said second line of chrominance, and said third line of chrominance are correlated and using a third filter to separate said chrominance component from said composite video signal.

20. The method as recited in claim 19 wherein said first filter is a comb filter.

21. The method as recited in claim 19 wherein said second filter is a band pass filter.

22. The method as recited in claim 19 wherein said third filter is a three-line comb filter.

23. The method as recited in claim 19 wherein said predetermined threshold value is a user defined threshold factor.

24. The method as recited in claim 19 wherein said predetermined threshold value is a user defined threshold factor multiplied by the average chrominance amplitude of said two consecutive lines of chrominance.
